(19) United States
(12) Patent Application Publication
(10) Pub. No.: US 2015/0310787 A1
(43) Pub. Date: Oct. 29, 2015

(54) EMS DISPLAYS INCORPORATING CONDUCTIVE EDGE SEALS AND METHODS FOR MANUFACTURING THEREOF

(71) Applicant: PIXTRONIX, INC., San Diego, CA (US)

(72) Inventors: Eugene Fike, Amesbury, MA (US); Ji Ma, Haverhill, MA (US)

(21) Appl. No.: 14/330,784

(22) Filed: Jul. 14, 2014

Related U.S. Application Data
(60) Provisional application No. 61/893,463, filed on Oct. 21, 2013.

(51) Int. Cl. G09G 3/20; G02B 26/02

(52) U.S. Cl. CPC G09G 3/20; G02B 26/02

(57) ABSTRACT

This disclosure provides systems, methods and apparatus for displaying images and for manufacturing display devices. Such displays can be fabricated in part by joining two substrates via a conductive seal. A substantially planar contact pad on at least one of the substrates can be exposed through a passivation layer via laser ablation, enabling the conductive seal to make contact with circuitry formed on the substrate.

### CROSS-REFERENCE TO RELATED APPLICATIONS

This Patent Application claims priority to U.S. Provisional Patent Application No. 61/893,463 filed Oct. 21, 2013, entitled “EMS Displays Incorporating Conductive Edge Seals And Methods For Manufacturing Thereof,” and assigned to the assignee hereof. The disclosure of the prior Application is considered part of and is incorporated by reference in this Patent Application.

### TECHNICAL FIELD

This disclosure relates to the field of displays, and in particular, to bonding techniques used to couple display substrates.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

### SUMMARY

The systems, methods and devices of the disclosure each have several innovative aspects, no single one of which is solely responsible for the desirable attributes disclosed herein.

One innovative aspect of the subject matter described in this disclosure can be implemented in a method. The method includes providing a passivated display panel, including a passivation layer deposited over a plurality of display elements that are fabricated over and coupled to a control matrix formed on a first substrate, removing at least a portion of the passivation layer along a periphery of the display panel using laser ablation, thereby revealing a substantially planar contact pad included in the control matrix, and coupling a second substrate to the first substrate using a conductive edge seal deposited such that at least a portion of the edge seal forms an electrical connection between the contact pad and a conductive element deposited on the second substrate. In some implementations, the conductive edge seal includes an epoxy in which a plurality of conductive elements are suspended. In some implementations, the method also can include filling a cavity between the first and second substrates within the bounds of the conductive edge seal with a liquid.

In some implementations, the conductive elements can include spheres coated with a conductive material, such as at least one of gold, silver, copper, and nickel. In some implementations, the edge seal further can include a plurality of rigid spacers suspended therein. In some implementations, coupling the second substrate to the first substrate can include compressing the edge seal such that at least a portion of the plurality of the conductive elements come into contact along an axis connecting the first and second substrates. In some implementations, the contact pad can be between about 250-750 microns wide.

Another innovative aspect of the subject matter described in this disclosure can be implemented in an apparatus. The apparatus includes a first and second substrates, and a plurality of display elements fabricated on the first substrate. The apparatus also includes a control matrix, which includes a substantially planar contact pad positioned along at least a portion of a periphery of the first substrate, and a conductive edge seal coupling the first substrate to the second substrate, thereby forming an electrical connection from the contact pad to a conductive element deposited on the second substrate. In some implementations, the contact pad is between about 250-750 microns wide. In some implementations, a liquid fills a cavity formed between the first and second substrates within the bounds of the conductive edge seal.

In some implementations, wherein the conductive edge seal includes an epoxy in which a plurality of conductive elements are suspended. In some such implementations, the conductive elements include spheres coated with a conductive material, such as at least one of gold, silver, copper, and nickel. In some implementations, the edge seal further includes a plurality of rigid spacers suspended therein. In some implementations, the edge seal is compressed such that at least a portion of the plurality of the conductive elements come into contact along an axis connecting the first and second substrates.

In some implementations, the apparatus further includes a display including the plurality of display elements, a processor that is configured to communicate with the display, the processor being configured to process image data, and a memory device that is configured to communicate with the processor. In some implementations, the apparatus further includes a driver circuit configured to send at least one signal to the display, and a controller configured to send at least a portion of the image data to the driver circuit. In some implementations, the apparatus further includes an image source module configured to send the image data to the processor, where the image source module includes at least one of a receiver, transceiver, and transmitter. In some implementations, the apparatus further includes an input device configured to receive input data and to communicate the input data to the processor.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows an example schematic diagram of a direct-view microelectromechanical systems (MEMS) based display apparatus.

FIG. 1B shows an example block diagram of a host device.

FIGS. 2A and 2B show views of an example dual actuator shutter assembly.

FIG. 3 shows a cross section of a portion of an example display assembly.

FIG. 4 shows a top view of an example contact pad incorporated into the display assembly shown in FIG. 3.

FIG. 5 shows a flow diagram of an example process for manufacturing a display assembly.

FIGS. 6A and 6B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Certain displays include a pair of opposing substrates separated from one another by a gap. An array of EMS-based light modulators is formed on one of the substrates (referred to as the EMS substrate) such that they are located within the gap. The two substrates are coupled together by a seal material, which surrounds the array. The seal material traps a fluid (liquid or gas) or a vacuum between the substrates. To prevent moving components of the light modulators from being electrostatically attracted to the opposing substrate, portions of the opposing substrate are maintained at an electric potential equal to the electric potential of the moving light modulator components. This equal potential is maintained by an electrical connection formed between the opposing substrates through the seal material. For example, the seal material can be formed from an epoxy in which conductive elements (such as conductor-coated microspheres) are suspended. Additional rigid spacers, slightly smaller in size than the conductive elements, may also be suspended in the epoxy.

During the process of manufacturing the light modulators, before the seal material is applied, a passivation layer is typically applied over the entirety of the structures formed on the EMS substrate. Thus, in order for the seal material to form an electrical connection between the substrates, a portion of the passivation layer is removed using, for example, laser ablation, such that the seal material can make contact with a contact pad formed on EMS substrate. In some implementations, to provide for an adequate contact surface for the EMS substrate and to facilitate adequate removal of the passivation layer material, the contact pad is patterned to have at least a sizable portion that is substantially planar.

Particular implementations of the subject matter described in this disclosure can be implemented to realize one or more of the following potential advantages. Laser ablation provides a relatively efficient and effective technique for removing sufficient portions of the passivation layer to provide an adequate contact surface for the seal material to make contact with. In addition, by having the contact pad have a significant area which is substantially planar and relatively large in size, a sufficient contact area can be exposed even given the relatively tight power window in which the laser can operate to remove the passivation layer without damaging the underlying components of the display. The inclusion of rigid spacers in the edge seal helps ensure a proper spacing between the substrates after compression, and helps prevent damage to the conductive elements.

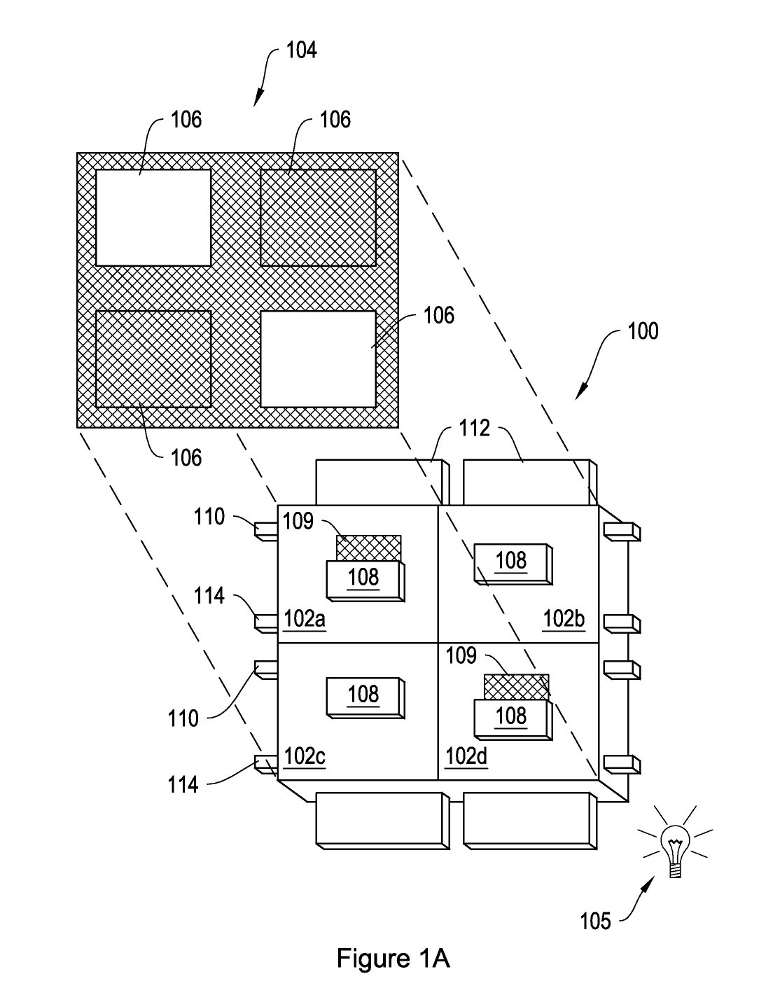

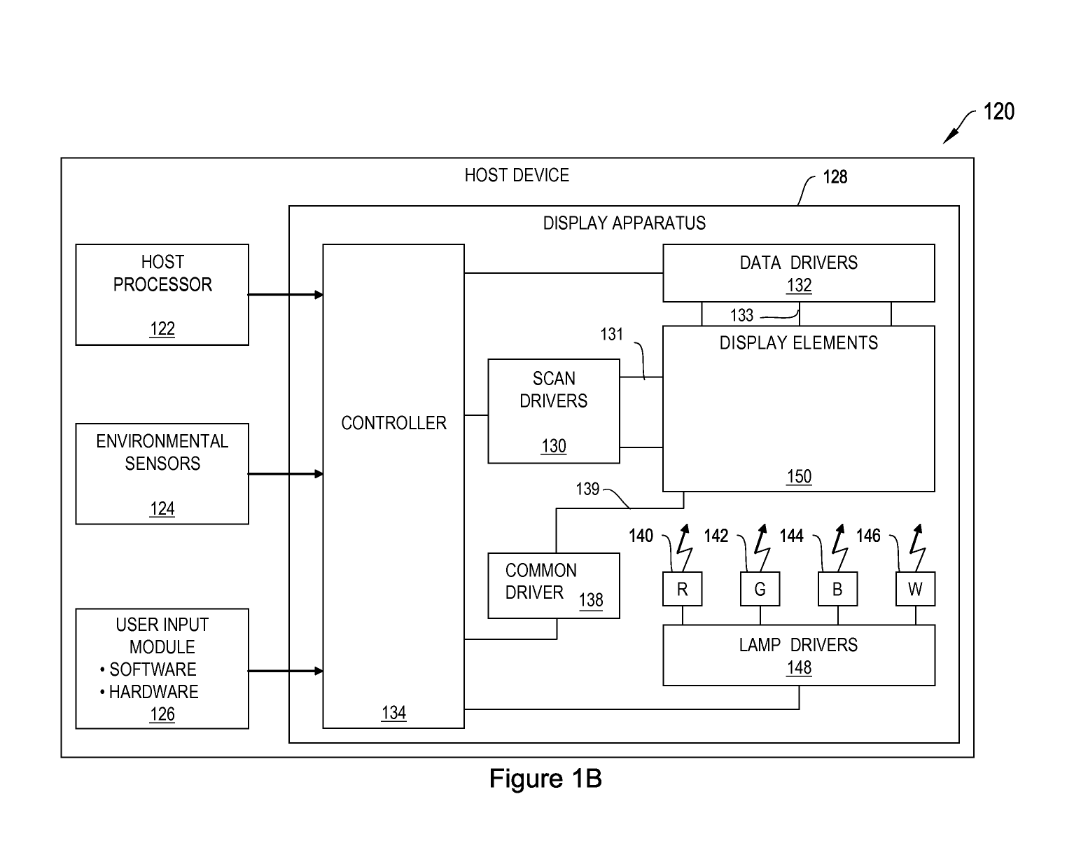

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying only a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for only a certain fraction of the image is loaded to the array of display elements 150. For example, the sequence can be implemented to address only every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

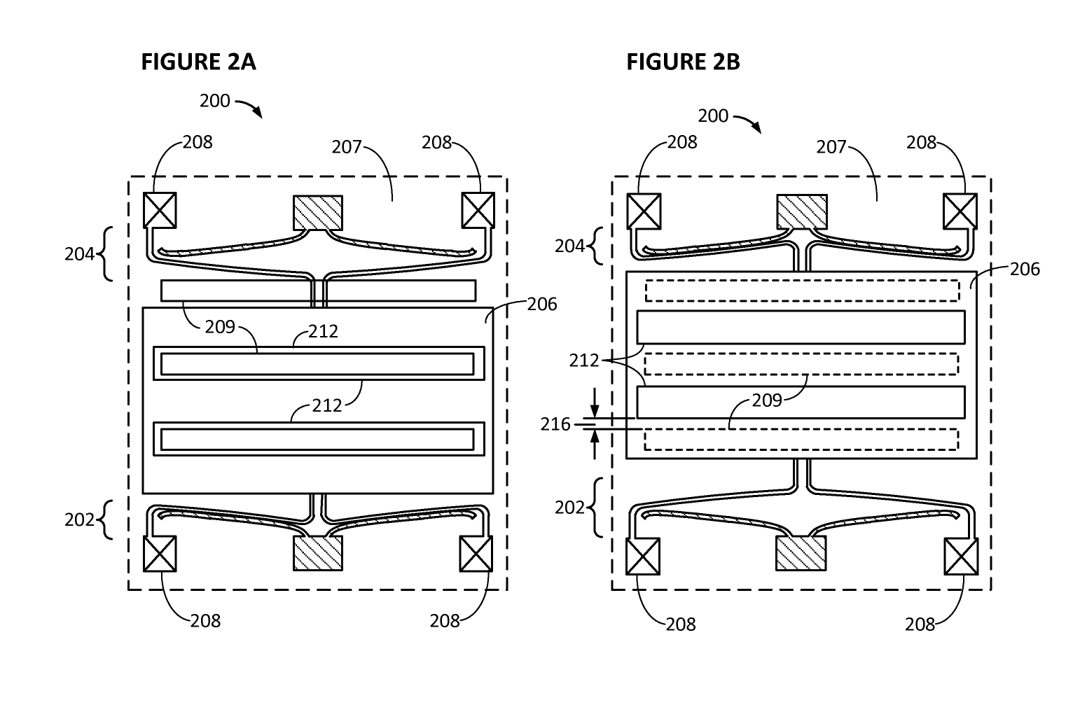

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have only a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage V.

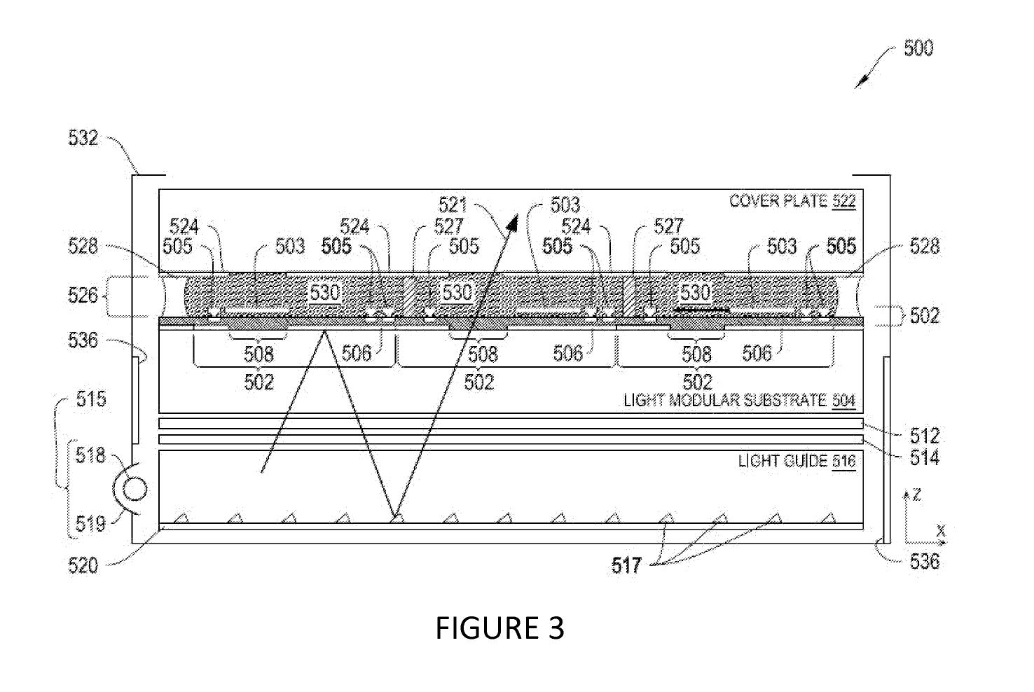

FIG. 3 shows an example cross sectional view of a display apparatus 500 incorporating shutter-based light modulators (shutter assemblies) 502. Each shutter assembly 502 incorporates a shutter 503 and an anchor 505. The shutter assemblies 502 are disposed on a transparent substrate 504, such a substrate made of plastic or glass. A rear-facing reflective layer, reflective film 506, disposed on the substrate 504 defines a plurality of surface apertures 508 located beneath the closed positions of the shutters 503 of the shutter assemblies 502. The reflective film 506 reflects light not passing through the surface apertures 508 back towards the rear of the display apparatus 500. The reflective aperture layer 506 can be a fine-grained metal film without inclusions formed in thin film fashion by a number of vapor deposition techniques including sputtering, evaporation, ion plating, laser ablation, or chemical vapor deposition (CVD). In some other implementations, the rear-facing reflective layer 506 can be formed from a mirror, such as a dielectric mirror. A dielectric mirror can be fabricated as a stack of dielectric thin films which alternate between materials of high and low refractive index. The vertical gap which separates the shutters 503 from the reflective film 506, within which the shutter is free to move, is in the range of 0.5 to 10 microns. The magnitude of the vertical gap is preferably less than the lateral overlap between the edge of shutters 503 and the edge of apertures 508 in the closed state.

The display apparatus 500 includes an optional diffuser 512 and/or an optional brightness enhancing film 514 which separate the substrate 504 from a planar light guide 516. The light guide 516 includes a transparent, i.e., glass or plastic material. The light guide 516 is illuminated by one or more light sources 518, forming a backlight. The light sources 518 can be, for example, and without limitation, incandescent lamps, fluorescent lamps, lasers or light emitting diodes (LEDs). A reflector 519 helps direct light from lamp 518 towards the light guide 516. A front-facing reflective film 520 is disposed behind the backlight 516, reflecting light towards the shutter assemblies 502. Light rays such as ray 521 from the backlight that do not pass through one of the shutter assemblies 502 will be returned to the backlight and reflected again from the film 520. In this fashion light that fails to leave the display apparatus 500 to form an image on the first pass can be recycled and made available for transmission through other open apertures in the array of shutter assemblies 502. Such light recycling has been shown to increase the illumination efficiency of the display.

The light guide 516 includes a set of geometric light redirectors or prisms 517 which redirect light from the lamps 518 towards the apertures 508 and hence toward the front of the display. The light redirectors 517 can be molded into the plastic body of light guide 516 with shapes that can be alternately triangular, trapezoidal, or curved in cross section. The density of the prisms 517 generally increases with distance from the lamp 518.

In some implementations, the aperture layer 506 can be made of a light absorbing material, and in alternate implementations the surfaces of shutter 503 can be coated with either a light absorbing or a light reflecting material. In some other implementations, the aperture layer 506 can be deposited directly on the surface of the light guide 516. In some implementations, the aperture layer 506 need not be disposed on the same substrate as the shutters 503 and anchors 505. For example, in some implementations, the shutters are fabricated on a rear-facing surface of the cover plate 522, and the aperture layer 506 is fabricated on a separate aperture plate, positioned between the light guide 516 and the cover plate 522, for example, where the substrate 504 is shown in FIG. 3.

In some implementations, the light sources 518 can include lamps of different colors, for instance, the colors red, green and blue. A color image can be formed by sequentially illuminating images with lamps of different colors at a rate sufficient for the human brain to average the different colored images into a single multi-color image. The various color-specific images are formed using the array of shutter assemblies 502. In another implementation, the light source 518 includes lamps having more than three different colors. For example, the light source 518 may have red, green, blue and white lamps, or red, green, blue and yellow lamps. In some other implementations, the light source 518 may include cyan, magenta, yellow and white lamps, red, green, blue and white lamps. In some other implementations, additional lamps may be included in the light source 518. For example, if using five colors, the light source 518 may include red, green, blue, cyan and yellow lamps. In some other implementations, the light source 518 may include white, orange, blue, purple and green lamps or white, blue, yellow, red and cyan lamps. If using six colors, the light source 518 may include red, green, blue, cyan, magenta and yellow lamps or white, cyan, magenta, yellow, orange and green lamps.

A cover plate 522 forms the front of the display apparatus 500. The rear side of the cover plate 522 can be covered with a light absorbing layer 524 to increase contrast. In alternate implementations the cover plate includes color filters, for instance distinct red, green, and blue filters corresponding to different ones of the shutter assemblies 502. The cover plate 522 is supported a predetermined distance away from the shutter assemblies 502 forming a gap 526. The gap 526 is maintained by mechanical supports or spacers 527 and/or by an adhesive seal 528 attaching the cover plate 522 to the substrate 504.

Displays that incorporate mechanical light modulators can include hundreds, thousands, or in some cases, millions of moving elements. In some devices, every movement of an element provides an opportunity for static friction to disable one or more of the elements. This movement is facilitated by immersing all the parts in a fluid (also referred to as fluid 530) and sealing the fluid (e.g., with an adhesive) within a fluid space or gap in a MEMS display cell. The fluid 530 is usually one with a low coefficient of friction, low viscosity, and minimal degradation effects over the long term.

A sheet metal or molded plastic assembly bracket 532 holds the cover plate 522, the substrate 504, the backlight and the other component parts together around the edges. The assembly bracket 532 is fastened with screws or indent tabs to add rigidity to the combined display apparatus 500. In some implementations, the light source 518 is molded in place by an epoxy potting compound. Reflectors 536 help return light escaping from the edges of the light guide 516 back into the light guide 516. Not depicted in FIG. 3 are electrical interconnects which provide control signals as well as power to the shutter assemblies 502 and the lamps 518.

The process of immersing various parts of the display apparatus 500 in the fluid 530 may result in charges migrating off such parts and into the fluid 530. Such charge migration also may result from friction between the shutters 503 and the fluid 530 when the shutters 503 are repeatedly moved between open and closed positions. In other instances, charge migration unrelated to friction with charged surfaces, such as the shutters 503, may cause the charge buildup.

Regardless of the causes, the charge buildup can produce undesirable effects in the operation of the display apparatus 500. In particular, the charge buildup can produce electrostatic forces between various parts of the display apparatus. Such electrostatic forces may cause undesirable movement of those parts. For example, a charge buildup on the cover plate 522 opposite the shutters 503 can exert electrostatic forces on the shutters 503 in a direction out of the plane of the shutters' intended motion. These forces may hinder the movement of the shutter 503. In some instances, the electrostatic forces due to the charge buildup may result in the shutter 503 sticking or adhering to other surfaces within the display element 500. The shutter 503 may then be stuck in an undesired open, closed, or intermediate position. In other instances, if the charge buildup is large enough, the resulting strong electrostatic forces may pull the shutter 503 with enough force to bend or irreversibly damage the beams and anchors 505 that support the shutter 503. This may cause the shutter 503 to be permanently damaged, rendering the corresponding pixel inoperable.

To mitigate the risk of such damage, the front light absorbing layer 524 of the display apparatus 500 can be formed from or include a conductive material. Moreover, the front light absorbing layer 524 is disposed such that one of its major surfaces is in electrical contact with the fluid 530. The front light absorbing layer 524 can be formed from the deposition and/or anodization of a number of light absorbing conductive materials, including without limitation, molybdenum chromium (MoCr), molybdenum tungsten (MoW), molybdenum titanium (MoTi), molybdenum tantalum (MoTa), titanium tungsten (TiW), and titanium chromide (TiCr). Metal films formed from the above alloys or simple metals, such as nickel (Ni) and chromium (Cr) with rough surfaces also can be effective at absorbing light. Such films can be produced by sputter deposition in high gas pressures (sputtering atmospheres in excess of 20 mTorr). Rough metal films also can be formed by the liquid spray or plasma spray application of a dispersion of metal particles, following by a thermal sintering stage. The front light absorbing layer 524 also can be formed using resin black matrix (RBM), which is light absorbing and sufficiently conductive.

The front light absorbing layer 524 can be configured in several ways to dissipate the charge buildup. In some other implementations, all shutters 503 of all the pixels are operated at the same global potential during operation. In such implementations, the front light absorbing layer 524 is electrically connected to all the shutters 503. In some implementations, the edge seals 528 incorporate conductive materials such that the edge seals 528 can electrically connect the front light absorbing layer 524 to interconnects that couple to the shutters 503. Maintaining the front light absorbing layer 524 and the shutters 503 at the same potential reduces or eliminates charge buildup on the cover plate 522.

In some implementations, to provide for a conductive edge seal, the edge seal is formed from an epoxy in which conductive particles are suspended. For example, microspheres coated with conductive metals, such as silver (Ag), copper (Cu), nickel (Ni), gold (Au) or alloys thereof, can be suspended in the epoxy. In some implementations, in order to prevent the conductive particles from interfering with the dispensing of the epoxy, the density of the particles in the epoxy is limited to no more than about 3% per volume. In some other implementations, the density of conductive particles in the epoxy is between about 1% and about 5% per volume. In some implementations, additional materials are added to the epoxy. For example, in some implementations, non-conductive, rigid spacers having diameters that are about 0.5 μm smaller than the coated microspheres, are also suspended in the epoxy. In other implementations, an alternative conductive material, such as silver or carbon paste, is used to form the edge seal.

The edge seal 528 electrically couples to a portion of the front light absorbing layer 524 along the perimeter of the array of pixels. On the light modulator substrate 504, the edge seal makes electrical contact with one or more contact pads located at various locations around the perimeter of the array.

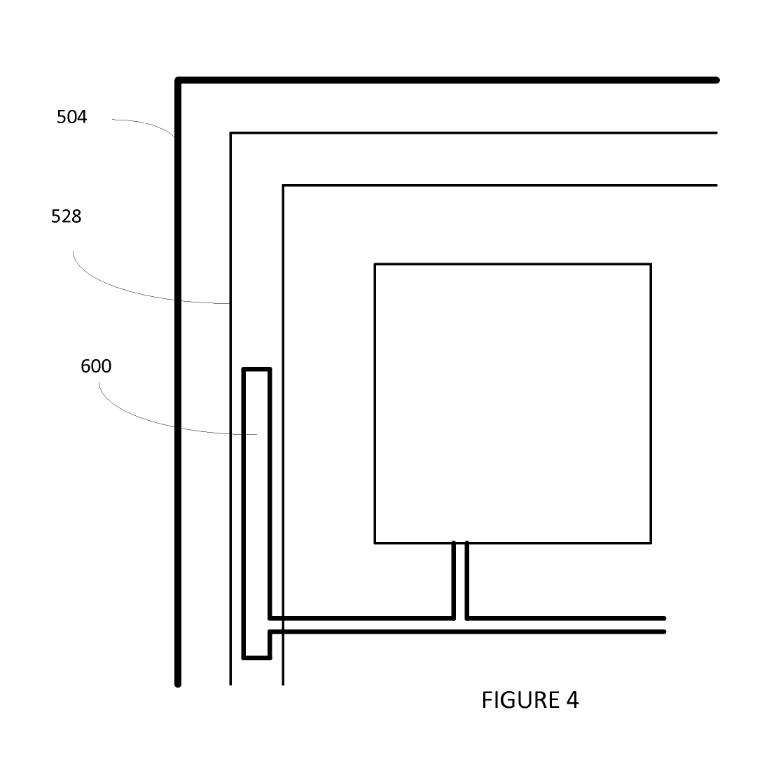

FIG. 4 shows a top view of an example contact pad 600 incorporated into the display assembly shown in FIG. 3. The contact pad 600 can range in size from about 2 to about 25 mm in length and from about 0.25 to about 0.75 mm in width. In some implementations, the contact pad 600 is about 1.0 mm wide. In implementations in which the contact pad is exposed by removal of a passivation layer via laser ablation, the width of the contact pad is set to be about equal to between about 1-3 times the spot size of the laser to limit the number of times the laser runs over the area to remove the passivation material. In some other implementations, the size of the contact pad 600 is determined based on the size of the conductive elements suspended in the epoxy. For example, in some implementations, the contact pad is patterned to have an area determined based on the amount of space an individual conductive element needs to contact the contact pad 600, the number of conductive elements desired to contact the contact pad 600, and the density of the conductive elements in the epoxy. For example, the area of the contact pad 600 may range from about 1.5 mm² (for example, about 500 μm×30 μm) to about 20 mm² (for example, about 10 mm×2 mm). Given the unevenness of the passivation layer removal process, additional area may be allocated to the contact pad 600 than may otherwise be needed to ensure a sufficient number of conductive elements make contact with the contact pad 600 even if the passivation layer is completely removed from the entire contact pad 600.

To facilitate effective removal of the passivation layer and to obtain sufficient electrical contact with the conductive elements suspended in the edge seal 528 shown in FIG. 4, a substantial portion (for example, greater than about 60%, greater than about 75%, or greater than about 85%) of the surface area contact pad 600 is substantially planar. An uneven contact pad 600 can result in an insufficient amount of passivation material being removed (if the passivation layer ends up being thicker in some regions) or damage to the contact pad (if less passivation layer material covers portions of the contact pad, resulting in the contact pad being exposed to the laser for an undesirable amount of time). Unevenness in the contact pad 600 may also prevent the conductive elements from making effective contact with the contact pad 600.

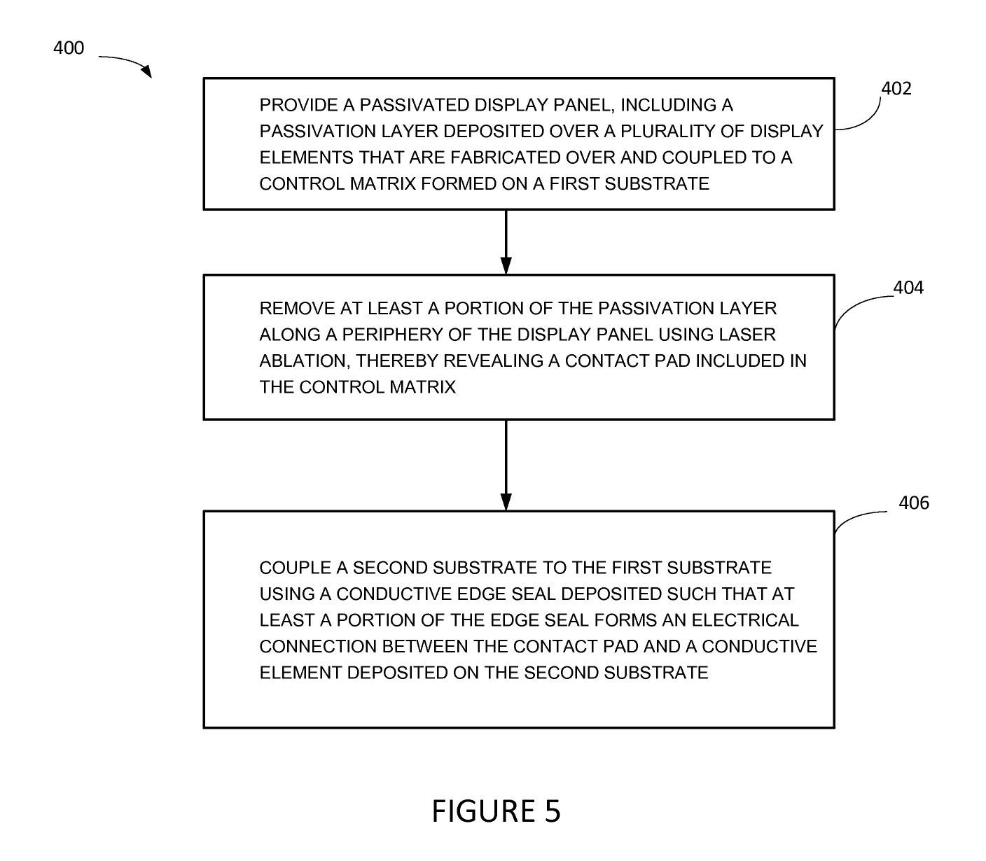

FIG. 5 shows a flow diagram of an example process for manufacturing a display assembly 400. The method includes providing a passivated display panel, including a passivation layer deposited over a plurality of display elements that are fabricated over and coupled to a control matrix formed on a first substrate (stage 402). The method also includes removing at least a portion of the passivation layer along a periphery of the display panel using laser ablation, thereby revealing a contact pad included in the control matrix (stage 404) and coupling a second substrate to the first substrate using a conductive edge seal deposited such that at least a portion of the edge seal forms an electrical connection between the contact pad and a conductive element deposited on the second substrate (stage 406).

As indicated above, the method 400 includes providing a passivated display panel, including a passivation layer deposited over a plurality of display elements that are fabricated over and coupled to a control matrix formed on a first substrate (stage 402). In some implementations, the display elements are MEMS shutter based display elements similar to the shutter assemblies 502 shown in FIG. 3 or the shutter assemblies 200 shown in FIGS. 2A and 2B. In some such implementations, providing the passivated display panel includes fabricating an aperture layer (such as the reflective aperture layer 506) over a transparent substrate (such as the light modulator substrate 504), forming a control matrix over the aperture layer, forming the MEMS shutter-based display elements (such the shutter assemblies 502 or 200) over the control matrix, releasing the MEMS-shutter-based display elements, and then applying a passivation layer over the exposed surfaces of the display elements and control matrix. The passivation layer can be deposited using a conformal deposition technique such as chemical vapor deposition, plasma enhanced chemical vapor deposition, atomic layer deposition, etc.

At least a portion of the passivation layer is then removed using laser ablation to expose a contact pad (such as the contact pad 600) patterned into the control matrix. Laser ablation is used, as opposed to etching, as etch processing is quite expensive, and for MEMS display elements, difficult to carry out once the MEMS display elements have been released from the mold on which they were formed. However, there is only a relatively narrow power window within which a laser can be used to remove portions of the passivation layer without damaging the underlying contact pad and remaining portions of the control matrix. If the power or exposure time is too high, the laser can cause damage to the display. If the power or exposure time is too low, the passivation layer will not be sufficiently removed in the desired area for the conductive edge seal to make an electrical connection with the contact pad. In some implementations, the laser is operated at between about 70 to about 100 mW. For example, in some implementations, the laser is operated at about 80 mW. Even under tight controls, the laser may not fully remove all of the passivation layer from over the contact pad. As such, the contact pad is patterned into a metal layer of the control matrix to be sufficiently large that a manufacturer can have sufficient confidence that enough of the contact pad is exposed to form a sufficient electrical connection through an edge seal deposited over the contact pad (as discussed further below). As described above, the contact pad can be on the order of 2-25 mm long, and between about 250 and 750 μm wide. In some implementations it can be longer or wider.

After the contact pad is sufficiently exposed, a second substrate (such as the cover sheet 522) is coupled to the first substrate using a conductive edge seal deposited such that at least a portion of the edge seal forms an electrical connection between the contact pad and a conductive element deposited on the second substrate (stage 406). As discussed above in relation to FIG. 3, the conductive edge seal can be formed from a polymer epoxy in which conductive elements are suspended. The conductive elements can be microspheres coated with a conductive metal, such as Ni or Au. The conductive edge seal is deposited around the perimeter of the array of display elements over the exposed contact pad(s). The second substrate is then pressed onto the seal, compressing the epoxy and bringing the conductive elements into contact with one another, forming an electrical connection between the contact pad and a conductive element on the second substrate, such as the front aperture layer 524 described above in relation to FIG. 3. Due to the relatively low density of the conductive elements in the epoxy, an electrical connection is formed substantially just in the direction of compression, and not across the width or along the length of the edge seal.

As indicated above, in some implementations, additional non-conductive, rigid spacers can also be suspended in the epoxy. During compression, these spacers help control the amount of compression and provide for a rigid stop to control the separation distance between the two substrates around the periphery of the display to a desired height. In some such implementations, during compression, the substrates are pressed together until they hit the rigid silica spacers, at which point the substrates will stop being pressed together. As the conductive elements tend to be somewhat compliant, in some implementations, without the rigid spacers, excessive compression of the substrates can end up damaging the conductive elements and may result in too small a separation distance between the substrates.

After the compression has stopped, the edge seal is cured. In some implementations, a gap or a hole is left in the edge seal to allow fluid to be introduced into the cavity formed between the two substrates. Fluid can be introduced, for example, using a vacuum filling process, after which the gap is sealed, trapping the fluid inside.

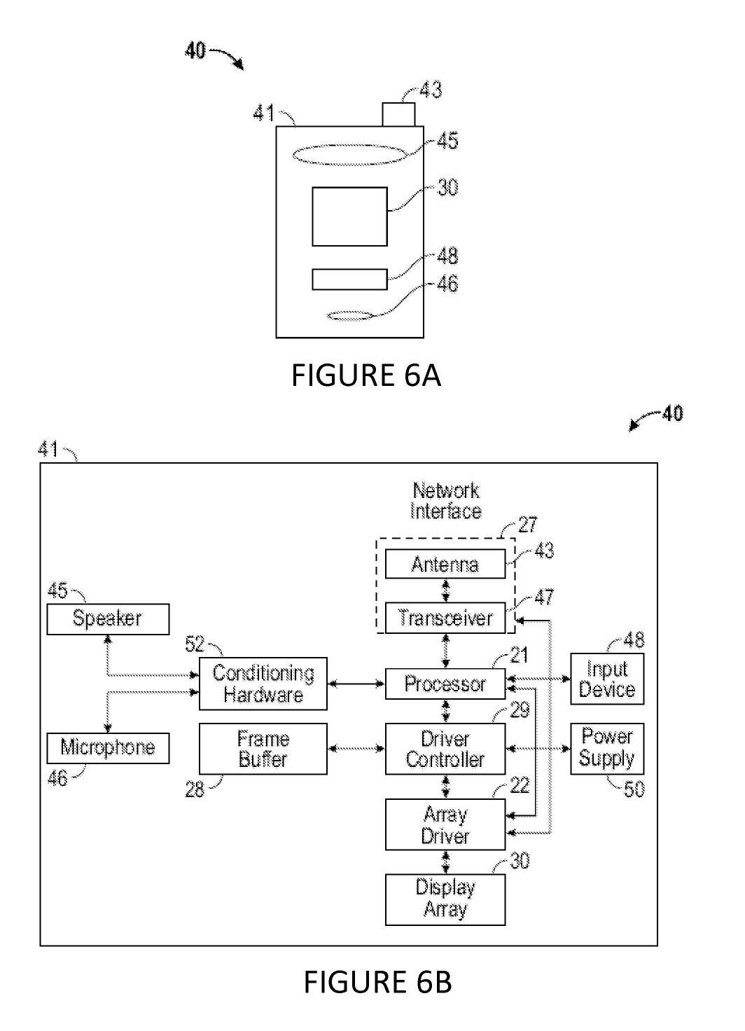

FIGS. 6A and 6B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 6B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 6A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method, comprising:
providing a passivated display panel, including a passivation layer deposited over a plurality of display elements that are fabricated over and coupled to a control matrix formed on a first substrate;
removing at least a portion of the passivation layer along a periphery of the display panel using laser ablation, thereby revealing a substantially planar contact pad included in the control matrix; and
coupling a second substrate to the first substrate using a conductive edge seal deposited such that at least a portion of the edge seal forms an electrical connection between the contact pad and a conductive element deposited on the second substrate.

2. The method of claim 1, wherein the conductive edge seal includes an epoxy in which a plurality of conductive elements are suspended.

3. The method of claim 2, wherein the conductive elements include spheres coated with a conductive material.

4. The method of claim 2, wherein the conductive elements are coated with one of at least gold, silver, copper, and nickel.

5. The method of claim 2, wherein coupling the second substrate to the first substrate includes compressing the edge seal such that at least a portion of the plurality of the conductive elements come into contact along an axis connecting the first and second substrates.

6. The method of claim 1, wherein the edge seal further includes a plurality of rigid spacers suspended therein.

7. The method of claim 1, wherein the contact pad is between about 250-750 microns wide.

8. The method of claim 1, further comprising filling a cavity between the first and second substrates within the bounds of the conductive edge seal with a liquid.

9. An apparatus, comprising:
a first substrate and a second substrate;
a plurality of display elements fabricated on the first substrate;
a control matrix fabricated on the first substrate, wherein the control matrix includes a substantially planar contact pad positioned along at least a portion of a periphery of the first substrate; and
a conductive edge seal coupling the first substrate to the second substrate and forming an electrical connection from the contact pad to a conductive element deposited on the second substrate.

10. The apparatus of claim 9, wherein the conductive edge seal includes an epoxy in which a plurality of conductive elements are suspended.

11. The apparatus of claim 10, wherein the conductive elements include spheres coated with a conductive material.

12. The apparatus of claim 10, wherein the conductive elements are coated with one of at least gold, silver, copper, and nickel.

13. The apparatus of claim 10, wherein the edge seal is compressed such that at least a portion of the plurality of the conductive elements come into contact along an axis connecting the first and second substrates.

14. The apparatus of claim 10, wherein the edge seal further includes a plurality of rigid spacers suspended therein.

15. The apparatus of claim 9, wherein the contact pad is between about 250-750 microns wide.

16. The apparatus of claim 9, further comprising a liquid filling a cavity between the first and second substrates within the bounds of the conductive edge seal.

17. The apparatus of claim 9, further comprising:
a display including the plurality of display elements;
a processor capable of communicating with the display, the processor being capable of processing image data; and
a memory device capable of communicating with the processor.

18. The apparatus of claim 17, further comprising:
a driver circuit capable of sending at least one signal to the display; and
a controller capable of sending at least a portion of the image data to the driver circuit.

19. The apparatus of claim 17, further comprising:
an image source module capable of sending the image data to the processor, wherein the image source module includes at least one of a receiver, transceiver, and transmitter.

20. The apparatus of claim 17, further comprising:
an input device capable of receiving input data and communicating the input data to the processor.
